(19) United States
(12) Patent Application Publication
(10) Pub. No.: US 2024/0062932 A1
(43) Pub. Date: Feb. 22, 2024

(54) FLEXIBLE FLAT CABLE WITH NO SECONDARY PROCESSING ADHESIVES

(71) Applicant: Bing Xu Precision Co., Ltd., New Taipei City (TW)

(72) Inventor: Chih-Jung CHEN, New Taipei City (TW)

(73) Assignee: Bing Xu Precision Co., Ltd., New Taipei City (TW)

(21) Appl. No.: 18/227,998

(22) Filed: Jul. 31, 2023

Related U.S. Application Data
(60) Provisional application No. 63/371,738, filed on Aug. 17, 2022.

(51) Int. Cl. H01B 7/08

(52) U.S. Cl. CPC H01B 7/0838; H01B 7/0861

(57) ABSTRACT

Provided is a flexible flat cable with no secondary processing adhesives. The flexible flat cable with no secondary processing adhesives includes a plurality of parallel arranged conductors, two insulation layers and two shielding layers. The two insulation layers have respective inner surfaces oppositely positioned to be adhered to sandwich the parallel arranged conductors. The two shielding layers are respectively adhered on respective outer surfaces of the two insulation layers. At least one of the inner surfaces or at least one of the outer surfaces of the two insulation layers is modified to have a modified surface layer possessing adhesibility.

### CROSS REFERENCE TO RELATED APPLICATION

This application claims the benefit of priority under 35 USC § 119(e) of U.S. Provisional Patent Application No. 63/371,738 filed on Aug. 17, 2022, the contents of which are incorporated by reference as if fully set forth herein in their entirety.

### FIELD OF THE INVENTION

The present disclosure relates to a flexible flat cable (FFC), and more particularly to a flexible flat cable (FFC) with no secondary processing adhesives as laminating the insulation layers and laminating the shielding layers.

### BACKGROUND OF THE INVENTION

A flexible flat cable (FFC) is a data conductor cable for transferring data between two electronic devices. Generally, a flexible flat cable (FFC) is made by multiple conductors arranged in parallel. Each conductor is covered by insulation layers to independently transfer signals or power. A flexible flat cable (FFC) is generally made by laminating insulation material and a flat copper line. The aforesaid cables can be easily used in all kinds of electronic devices because of some advantages such as parallel arranged conductors, data transmission rate, low volume, flexibility and easy assembly. Especially, the flexible flat cable (FFC) is widely used between two movable parts because it is bendable. For example, the flexible flat cable (FFC) could be welded with two connecters to connect two circuit boards or could be welded on the printable circuit board of the connector such that the signals could be transmitted to another device through the flexible flat cable (FFC).

However, as laminating each of the insulation layers and the aluminum foil layers to hold the parallel arranged conductors, the adhesive layer is essentially required. All the multiple layers (including the adhesive layers) possess the higher dielectric constant values and/or the higher dielectric loss values to result the insertion loss. Particularly, the adhesive with poor electrical property may severely affect the ultimate electrical characteristics of the flexible flat cable (FFC). Consequently, it inevitably causes the excessive problem of signal attenuation as the flexible flat cable (FFC) transmits the signals.

Therefore, there is a need to provide a flexible flat cable with better electrical characteristics.

### SUMMARY

As mentioned above, an adhesive layer is essentially required when the conductors are adhered and sandwiched by the insulation layers, and an adhesive layer is also required when the shielding layer (aluminum foil layer) is adhered to the insulation layer in the prior arts. As long as these adhesive layers are necessary in the manufacturing process, they will eventually affect the electrical characteristics of the flexible flat cable (FFC) itself, such as insertion loss and characteristic impedance. When the flexible flat cable (FFC) is utilized for high-frequency signal transmission, there will be extremely strict requirements for these electrical characteristics. To further improve the electrical characteristics of flexible flat cable (FFC), in addition to adopting high-quality and expensive insulation layer materials (such as Ultra High Molecular Weight Polyethylene, UHMW-PE), the adhesive layer has become another important consideration.

Based on the inventors' R&D experience for many years, once the FFC is added with one more layer in its layer structure (even one adhesive layer), the electrical characteristics, such as insertion loss and characteristic impedance will be affected. Therefore, the present invention proposes a flexible flat cable with no secondary processing adhesives, comprising a plurality of parallel arranged conductors; two insulation layers, having respective inner surfaces oppositely positioned to be adhered to sandwich the plurality of parallel arranged conductors; two shielding layers, respectively adhered on respective outer surfaces of the two insulation layers, wherein at least one of the inner surfaces of the two insulation layers is modified to comprise a modified surface layer possessing adhesibility. The flexible flat cable (FFC) does not require any secondary processing adhesive layer when the insulation layers are adhered so that the conductors sandwiched by the insulation layers, and when the shielding layer (aluminum foil layer) is adhered to the insulation layer.

Meanwhile, the present invention proposes a flexible flat cable with no secondary processing adhesives, comprising a plurality of parallel arranged conductors; two insulation layers having respective inner surfaces oppositely positioned to be adhered to sandwich the plurality of parallel arranged conductors; two shielding layers, respectively adhered on respective outer surfaces of the two insulation layers, wherein at least one of the outer surfaces of the two insulation layers is modified to comprise a modified surface layer possessing adhesibility.

Furthermore, it can be known through the following experiments and verifications that the electrical characteristics of the flexible flat cable (FFC) of the present invention are better than the electrical characteristics of the flexible flat cable (FFC) made of expensive insulation layers (such as the insulation layers made of ultra-high molecular weight polyethylene UHMW-PE). Under the conditions of relatively more simple process and relatively lower manufacturing cost, the present invention can still exhibit more excellent electrical characteristics of the flexible flat cable (FFC).

In the skill field of the FFC, polyethylene terephthalate (PET) films are commonly adopted as the insulation layers. Significantly, the flexible flat cable (FFC) produced by the present invention adopts a polypropylene (PP) layer as the insulation layer. The flexible flat cable (FFC) of the present invention only requires parallel arranged conductors, insulation layers (PP layers) and shielding layers (aluminum foil layers). Furthermore, the present invention is not limited to adopt the polypropylene (PP) layer as the insulation layer, other layers formed by different materials with similar properties also can be considered to be the insulation layer. Particularly, the insulation layers (PP layers) can be surface-modified polypropylene (PP) layers. In the present invention application, the surface-modified polypropylene (PP) layers are adopted. Originally, the polypropylene (PP) layers possess no adhesibility. After modifying the surface of the polypropylene (PP) layer, at least one surface of the polypropylene (PP) layer becomes more adhesible. Once the surface-modified polypropylene (PP) layers are thermally pressed with each other or with other layers, the layers can be firmly adhered. Alternatively, surface-modified polyolefin layers may also be illustrated.

Accordingly, with adopting the aforesaid surface-modified polypropylene (PP) layers, the flexible flat cable (FFC) of the present application can be produced without any secondary processing adhesives by utilizing the adhesibility of the surface-modified polypropylene (PP) layer itself.

### BRIEF DESCRIPTION OF THE DRAWINGS

FIG. 1 is a diagram of tested insertion loss vs. frequency relationship of a flexible flat cable (FFC, 30 cm) adopting Ultra High Molecular Weight Polyethylene (UHMW-PE) layers as insulation layers.

FIG. 2 is a diagram of tested characteristic impedance vs. time relationship of a flexible flat cable (FFC, 30 cm) adopting Ultra High Molecular Weight Polyethylene (UHMW-PE) layers as insulation layers.

FIG. 3 is a diagram of tested insertion loss vs. frequency relationship of a flexible flat cable (FFC, 30 cm) adopting polytetrafluoroethylene (PTFE) layers as insulation layers (as indicated by the first line) compared with Ultra High Molecular Weight Polyethylene (UHMW-PE) layers (i.e. the line shown in FIG. 1).

FIG. 4 is a diagram of tested characteristic impedance vs. time relationship of a flexible flat cable (FFC, 30 cm) adopting polytetrafluoroethylene (PTFE) layers as insulation layers (as indicated by the second line) compared with Ultra High Molecular Weight Polyethylene (UHMW-PE) layers (i.e. the line shown in FIG. 2).

FIG. 5 is a diagram of tested insertion loss vs. frequency relationship of a first flexible flat cable (FFC, 30 cm) adopting polypropylene (PP) layers as insulation layers.

FIG. 6 is a diagram of tested characteristic impedance vs. time relationship of a first flexible flat cable (FFC, 30 cm) adopting polypropylene (PP) layers as insulation layers.

FIG. 7 is a diagram of tested insertion loss vs. frequency relationship of a second flexible flat cable (FFC, 30 cm) adopting polypropylene (PP) layers as insulation layers.

FIG. 8 is a diagram of tested characteristic impedance vs. time relationship of a second flexible flat cable (FFC, 30 cm) adopting polypropylene (PP) layers as insulation layers.

FIG. 9 is a diagram of tested insertion loss vs. frequency relationship of a third flexible flat cable (FFC, 30 cm) adopting polypropylene (PP) layers as insulation layers.

FIG. 10 is a diagram of tested characteristic impedance vs. time relationship of a third flexible flat cable (FFC, 30 cm) adopting polypropylene (PP) layers as insulation layers.

FIG. 11 is a diagram of tested insertion loss vs. frequency relationship of a fourth flexible flat cable (FFC, 30 cm) adopting polypropylene (PP) layers as insulation layers.

FIG. 12 is a diagram of tested characteristic impedance vs. time relationship of a fourth flexible flat cable (FFC, 30 cm) adopting polypropylene (PP) layers as insulation layers.

FIG. 13 is a sectional structure diagram of a flexible flat cable (FFC) according to the present application.

### DETAILED DESCRIPTION OF PREFERRED EMBODIMENTS

Specifically, the terminologies in the embodiments of the present disclosure are merely for describing the purpose of the certain embodiment, but not to limit the invention. Examples and the appended claims be implemented in the present disclosure requires the use of the singular form of the book “an”, “the” and “the” are intended to include most forms unless the context clearly dictates otherwise. It should also be understood that the terminology used herein that “and/or” means and includes any or all possible combinations of one or more of the associated listed items.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

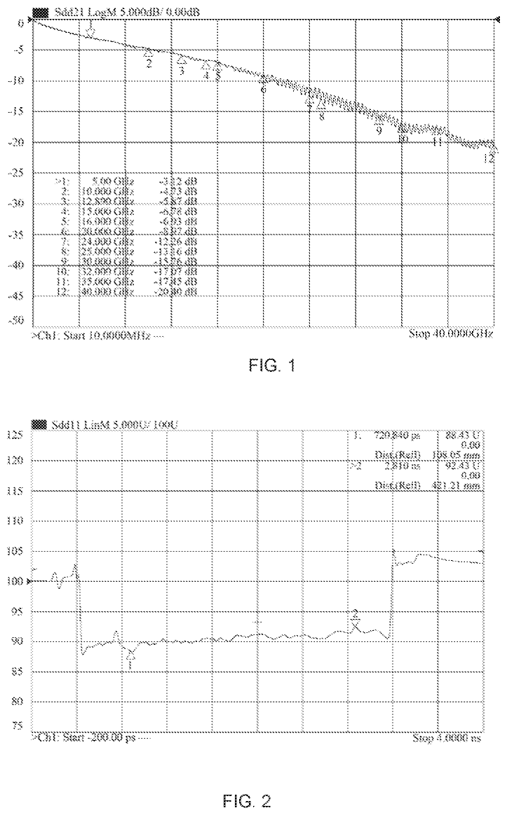

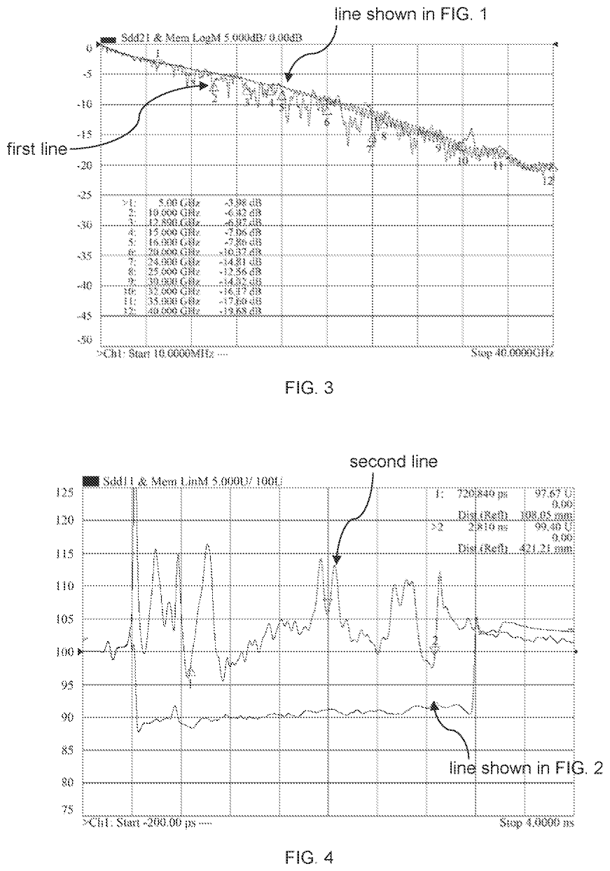

Please refer to FIG. 1 and FIG. 2. FIG. 1 is a diagram of tested insertion loss vs. frequency relationship of a flexible flat cable (FFC, 30 cm) adopting Ultra High Molecular Weight Polyethylene (UHMW-PE) layers as insulation layers. FIG. 2 is a diagram of tested characteristic impedance vs. time relationship of a flexible flat cable (FFC, 30 cm) adopting Ultra High Molecular Weight Polyethylene (UHMW-PE) layers as insulation layers.

In this compared embodiment, the flexible flat cable (FFC) comprises flat conductors, insulation layers and shielding layers (aluminum foil layers). Moreover, two adhesive layers, i.e. the low k/low f adhesives and the adhesives (Polyolefin) are provided between the flat conductors and the insulation layers. For instance, two low k/low f adhesives are provided to fix the parallel arranged flat conductors, and then the adhesive (Polyolefin) are provided on the surfaces of the Ultra High Molecular Weight Polyethylene (UHMW-PE) layers. Then, two Ultra High Molecular Weight Polyethylene (UHMW-PE) layers are oppositely arranged to be thermally pressed to sandwich the parallel arranged flat conductors inbetween. Then, the adhesives (Polyolefin) are provided on the surfaces of the shielding layers to be adhered on the outer surfaces of the Ultra High Molecular Weight Polyethylene (UHMW-PE) layers. Alternatively, two aluminum foil layers or copper foil layers may also be employed to be one shielding layer.

As well known, polyethylene terephthalate (PET) is a common material, which is employed to prepare the insulation layers. Meanwhile, many new materials are considered for forming the insulation layers. As shown in FIG. 1, Ultra High Molecular Weight Polyethylene (UHMW-PE) is one of the many candidates. With the excellent chemical, physical and electrical characteristics, the Ultra High Molecular Weight Polyethylene (UHMW-PE) layer indeed is a good choice for the insulation layers. The insertion loss of the flexible flat cable (FFC) formed therewith still can be kept almost −20 dB at the high frequency of 40 GHz. Meanwhile, the characteristic Impedance of the flexible flat cable (FFC) is about 88 to 92 as shown in FIG. 2.

Please refer to FIG. 3 and FIG. 4. FIG. 3 is a diagram of tested insertion loss vs. frequency relationship of a flexible flat cable (FFC, 30 cm) adopting polytetrafluoroethylene (PTFE) layers as insulation layers (as indicated by the first line) compared with Ultra High Molecular Weight Polyethylene (UHMW-PE) layers (i.e. the line shown in FIG. 1). FIG. 4 is a diagram of tested characteristic impedance vs. time relationship of a flexible flat cable (FFC, 30 cm) adopting polytetrafluoroethylene (PTFE) layers as insulation layers (as indicated by the second line) compared with Ultra High Molecular Weight Polyethylene (UHMW-PE) layers (i.e. the line shown in FIG. 2). As shown in FIG. 3, the insertion loss of the flexible flat cable (FFC) adopting polytetrafluoroethylene (PTFE) layers as insulation layers can be kept about −19.68 dB at the high frequency of 40 GHz but the characteristic Impedance of the flexible flat cable (FFC) adopting polytetrafluoroethylene (PTFE) layers as insulation layers is unstable and roughly between 97 and 115 as shown in FIG. 4.

The polytetrafluoroethylene (PTFE) is also a kind of material, which possesses excellent chemical, physical and electrical characteristics, for preparing an insulation layer. However, it is not common in the skill field of flexible flat cable (FFC) because the other layers are difficult to be adhered on the polytetrafluoroethylene (PTFE) layer, even any adhesive layers are added between the polytetrafluoroethylene (PTFE) layer and other layer for enhancing the adhesibility. With the comparison shown in FIG. 3 and FIG. 4, it shows that both the Ultra High Molecular Weight Polyethylene (UHMW-PE) layer and the polytetrafluoroethylene (PTFE) layer can provide the excellent electrical characteristics as being the insulation layers of the flexible flat cable (FFC). Nevertheless, the price of the Ultra High Molecular Weight Polyethylene (UHMW-PE) layer is too high and the polytetrafluoroethylene (PTFE) layer has the issue of difficult adhesion with the other layers. Either of them possesses inevitable drawbacks as being applied as the insulation layers of the flexible flat cable (FFC).

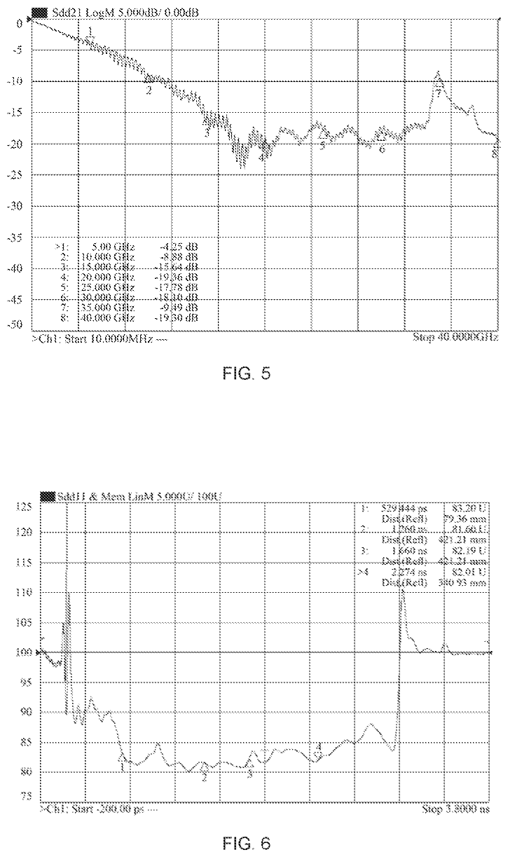

Please refer to FIG. 5 and FIG. 6. FIG. 5 is a diagram of tested insertion loss vs. frequency relationship of a first flexible flat cable (FFC, 30 cm) adopting polypropylene (PP) layers as insulation layers. FIG. 6 is a diagram of tested characteristic impedance vs. time relationship of a first flexible flat cable (FFC, 30 cm) adopting polypropylene (PP) layers as insulation layers. As aforementioned, the surface-modified polypropylene (PP) layers are employed as the insulation layers in the present application. Therefore, the flexible flat cable (FFC) of the present application mainly comprises parallel arranged conductors (e.g. mainly formed with copper), insulation layers (PP layers) and shielding layers (aluminum foil layers or copper foil layers). As shown in FIG. 5, the insertion loss of the first flexible flat cable (FFC) still can be kept almost −20 dB at the high frequency of 40 GHz. Thus, the insertion loss of the flexible flat cable (FFC) can be smaller than −25 dB as a tested frequency of the flexible flat cable is lower than 40 GHz. Meanwhile, the characteristic Impedance of the flexible flat cable (FFC) is about 80 to 87 as shown in FIG. 6. Alternatively, polyolefin layers may also be illustrated. As well as the foregoing polypropylene (PP) layers, the surface-modified polyolefin layers can be employed as the insulation layers in the present invention.

Significantly, the first flexible flat cable (FFC) adopting polypropylene (PP) layers as insulation layers in this embodiment is a preliminary handmade cable. The adhesion process of the layers is manually implemented. Some adhesive layers are still employed to sandwich the parallel arranged conductors by thermally pressing the polypropylene (PP) layers with each other. Thereafter, the shielding layers (aluminum foil layers or copper foil layers) are manually adhered on the outer sides of the polypropylene (PP) layers with adhesive layers after thermally pressing the insulation layers (PP layers) to sandwich the parallel arranged conductors. It is known that the so-called secondary processing adhesive is that the adhesive is firstly processed (the first processing, heated) when the adhesive is formed on the surface of the insulation layer or the shielding layer. Then, as the polypropylene (PP) layers are thermally pressed to each other or the shielding layer is adhered to the polypropylene (PP) layer, the adhesive needs to be processed again, that is, the secondary processing (heated).

In this embodiment, even though the adhesive layers are still included in the preparation of the flexible flat cable (FFC), the insertion loss of the flexible flat cable (FFC) still can be kept almost −20 dB at the high frequency of 40 GHz, which is comparable with the flexible flat cable (FFC) utilizing the Ultra High Molecular Weight Polyethylene (UHMW-PE) layers or the polytetrafluoroethylene (PTFE) layers as insulation layers as shown in FIG. 1 and FIG. 3. So far, it has been proved that the polypropylene (PP) layer is an excellent choice for the insulation layers of the flexible flat cable (FFC).

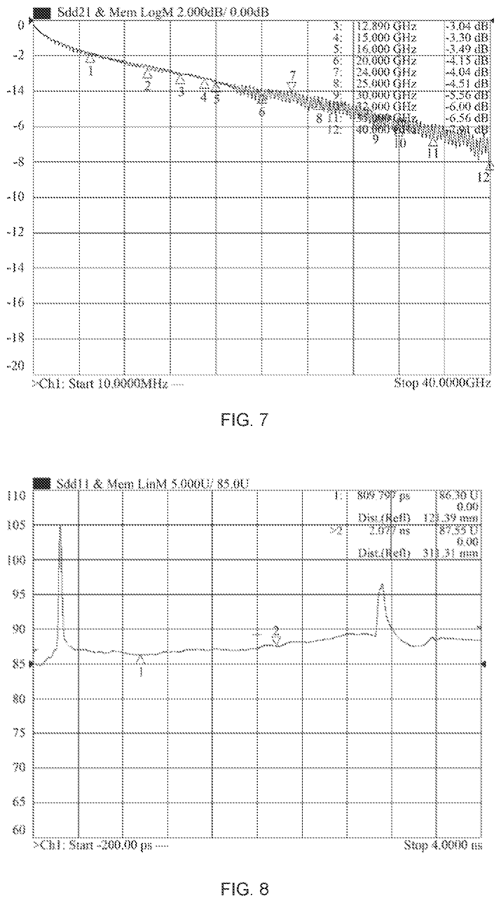

Furthermore, please refer to FIG. 7 and FIG. 8. FIG. 7 is a diagram of tested insertion loss vs. frequency relationship of a second flexible flat cable (FFC, 30 cm) adopting polypropylene (PP) layers as insulation layers. FIG. 8 is a diagram of tested characteristic impedance vs. time relationship of a second flexible flat cable (FFC, 30 cm) adopting polypropylene (PP) layers as insulation layers. Significantly, in this embodiment, the second flexible flat cable (FFC) of the present application only requires parallel arranged conductors, insulation layers (PP layers) and shielding layers (aluminum foil layers or copper foil layers), and significantly, no secondary processing adhesives are required. Originally, the surfaces (inner surface facing the conductors and the outer surface facing the shielding layer) of the polypropylene (PP) layer do not possess adhesibility before the surfaces are modified. After the surface modification, the surface-modified polypropylene (PP) layer may comprise modified surface layers formed at the inner surface and the outer surface of the polypropylene (PP) layer.

Through the inventor's experiments and verifications, it can be known that even if the surface modification is only implemented on the inner surface or the outer surface of one polypropylene (PP) layer and the conventional secondary processing adhesives are still used for adhering a layer with the other layer, the ultimate electrical characteristics, such as insertion loss and characteristic impedance of the flexible flat cable (FFC) have been significantly improved. However, as the surface modification is only implemented on the inner surface and outer surface of one single polypropylene (PP) layer, or only implemented on the inner surfaces or the outer surfaces of the two polypropylene (PP) layers, or even comprehensively implemented on the inner surfaces and the outer surfaces of the two polypropylene (PP) layers, it can make the ultimate electrical characteristics, such as insertion loss and characteristic impedance of the flexible flat cable (FFC) be obviously more and more excellent. In the first to fourth flexible flat cables (FFCs) of the present application, the surface modification is comprehensively implemented on both the inner surfaces and outer surfaces of the two polypropylene (PP) layers and these flexible flat cables (FFCs) are tested for the electrical characteristics as the embodiments.

Namely, the surface-modified polypropylene (PP) layer, i.e. the insulation layer comprises the modified surface layers. Meanwhile, a melting point of the modified surface layer is lower than a melting point of the two insulation layers. For instance, the melting point of the modified surface layer can be preferably in a range of 100-125° C. Meanwhile, the melting point of the polypropylene (PP) layers can be preferably in a range of 160-170° C. Significantly, the surface modification is to make the polypropylene (PP) layer, which previously possesses no adhesibility, become a surface-adhesible insulation layer. As regarding the skill of the surface modification and the preparation of the surface-modified insulation layers, related skills can be referred to several citations, such as public patent applications CN1390906A, CN112318843A and CN102208576A.

After modifying the both surfaces of the polypropylene (PP) layer, both two surfaces (inner surface facing the conductors and the outer surface facing the shielding layer) of polypropylene (PP) layer become more adhesible. Once they are thermally pressed with each other or with other layers, which are not polypropylene (PP) layers, the layers can be firmly adhered together without any additional secondary processing adhesives between the layers. Significantly, a polypropylene (PP) layer can be adhered with a shielding layer (aluminum foil layer), first. This step of preparation of the second flexible flat cable (FFC) can be implemented by thermal pressing to the side of the shielding layer with a heating roller after the polypropylene (PP) layer and the shielding layer are aligned to be in contact with each other in their respective surfaces before being rolled to the heating roller. After the heating roller, the polypropylene (PP) layer and the shielding layer are firmly adhered with each other. Specifically, the heating roller heats and presses the layers from the side of the shielding layer. Then, two polypropylene (PP) layers (both are adhered with the shielding layer in advance) sandwiching the parallel arranged conductors inbetween (the shielding layers are at the outer sides facing the heating rollers) are rolled into a slit between two heating rollers, again. The two heating rollers are employed to thermally press the two polypropylene (PP) layers to be firmly adhered with each other and meanwhile, employed to thermally press the two polypropylene (PP) layers to firmly sandwich the parallel arranged conductors between the two polypropylene (PP) layers.

As shown in FIG. 7, the insertion loss of the second flexible flat cable (FFC) can be remarkably kept almost at −7.91 dB at the high frequency of 40 GHz. Thus, the insertion loss of the flexible flat cable (FFC) with no secondary processing adhesives is smaller than −10 dB as a tested frequency of the flexible flat cable with no secondary processing adhesives is lower than 40 GHz. Meanwhile, the characteristic Impedance of the second flexible flat cable (FFC) is about 86 to 88 as shown in FIG. 8. Furthermore, as shown in FIG. 7, the vibration of the insertion loss of the second flexible flat cable (FFC) is remarkably small.

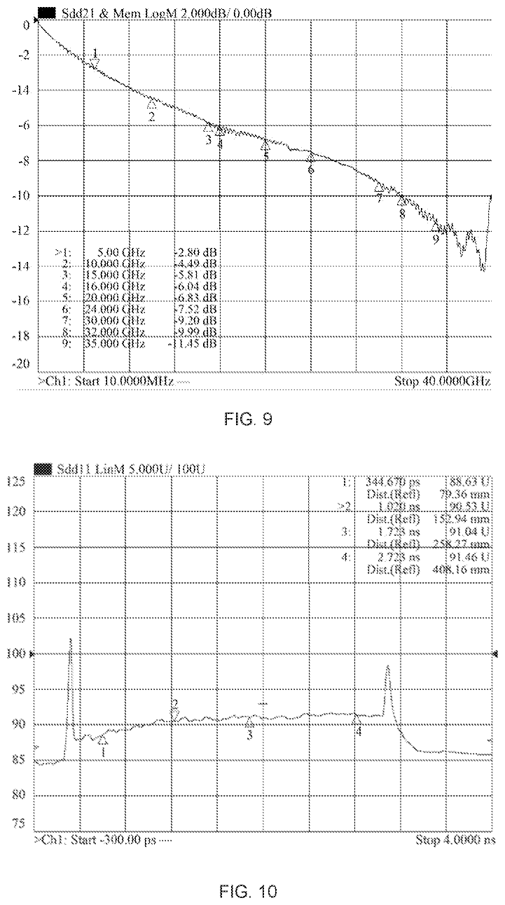

Please refer to FIG. 9 and FIG. 10. FIG. 9 is a diagram of tested insertion loss vs. frequency relationship of a third flexible flat cable (FFC, 30 cm) adopting polypropylene (PP) layers as insulation layers. FIG. 10 is a diagram of tested characteristic impedance vs. time relationship of a third flexible flat cable (FFC, 30 cm) adopting polypropylene (PP) layers as insulation layers. In this embodiment, the third flexible flat cable (FFC) of the present application still only requires parallel arranged conductors, insulation layers (PP layers) and shielding layers (aluminum foil layers or copper foil layers), and similarly, no secondary processing adhesives are required. The significant difference of the third flexible flat cable (FFC) of the present application from the second flexible flat cable (FFC) is that the surfaces of the parallel arranged conductors are formed with tin in advance. Then, the insulation layers (PP layers) are firmly adhered with each other to sandwich the parallel arranged conductors without the secondary processing adhesives.

As shown in FIG. 9, the insertion loss of the third flexible flat cable (FFC) can be kept almost at −11.45 dB at the high frequency of 35 GHz. Thus, the insertion loss of the flexible flat cable (FFC) with no secondary processing adhesives is smaller than −15 dB as a tested frequency of the flexible flat cable with no secondary processing adhesives is lower than 35 GHz. Meanwhile, the characteristic Impedance of the third flexible flat cable (FFC) is about 88 to 91 as shown in FIG. 10. The insertion loss of the third flexible flat cable (FFC) is obviously smaller than that of the flexible flat cable (FFC) utilizing the Ultra High Molecular Weight Polyethylene (UHMW-PE) layers but obviously larger than the insertion loss (−6.56 db/35 GHz) of the second flexible flat cable (FFC). Furthermore, as shown in FIG. 9, the vibration of the insertion loss of the third flexible flat cable (FFC) can be remained small.

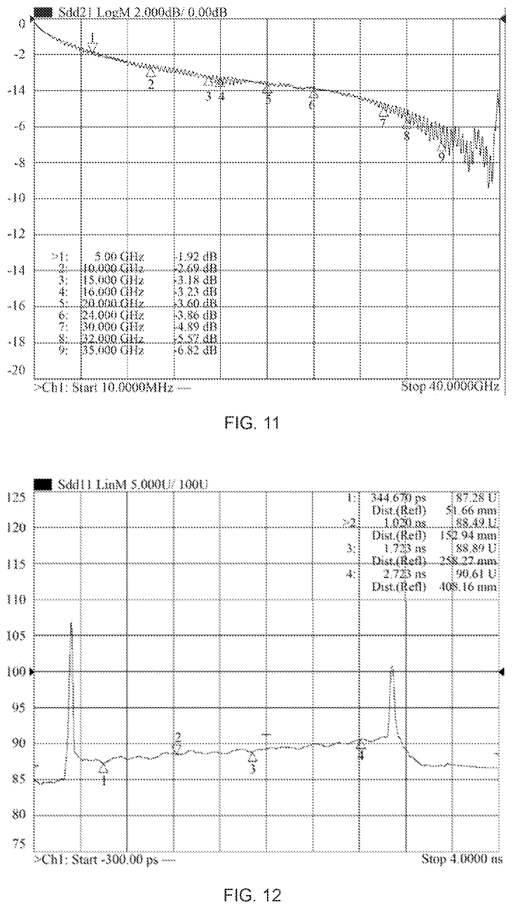

Please refer to FIG. 11 and FIG. 12. FIG. 11 is a diagram of tested insertion loss vs. frequency relationship of a fourth flexible flat cable (FFC, 30 cm) adopting polypropylene (PP) layers as insulation layers. FIG. 12 is a diagram of tested characteristic impedance vs. time relationship of a fourth flexible flat cable (FFC, 30 cm) adopting polypropylene (PP) layers as insulation layers. Similarly, in this embodiment, the fourth flexible flat cable (FFC) of the present application still only requires parallel arranged conductors, insulation layers (PP layers) and shielding layers (aluminum foil layers or copper foil layers), and still, no secondary processing adhesives are required. The significant difference of the fourth flexible flat cable (FFC) of the present application from the second flexible flat cable (FFC) is that the surfaces of the parallel arranged conductors are formed with silver in advance. Then, the insulation layers (PP layers) are firmly adhered with each other to sandwich the parallel arranged conductors without any secondary processing adhesives.

As shown in FIG. 11, the insertion loss of the fourth flexible flat cable (FFC) can be kept almost at −6.82 dB at the high frequency of 35 GHz. Thus, the insertion loss of the flexible flat cable (FFC) with no secondary processing adhesives is smaller than −10 dB as a tested frequency of the flexible flat cable with no secondary processing adhesives is lower than 35 GHz. Meanwhile, the characteristic Impedance of the fourth flexible flat cable (FFC) is about 87 to 90 as shown in FIG. 12. The insertion loss of the fourth flexible flat cable (FFC) is slightly higher than the insertion loss (−6.56 db/35 GHz) of the second flexible flat cable (FFC). Furthermore, as shown in FIG. 11, the vibration of the insertion loss of the fourth flexible flat cable (FFC) is also small but a little larger than the vibration of the insertion loss of the second flexible flat cable (FFC) at the high frequency range about 35 GHz to 40 GHz.

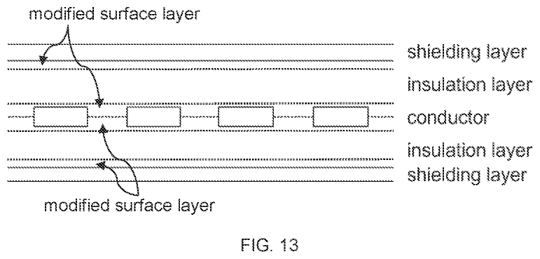

Please refer to FIG. 13, which is a sectional structure diagram of a flexible flat cable (FFC) according to the present application. The flexible flat cable (FFC) of the present application comprises only requires parallel arranged conductors (flat or round), an upper insulation layer (PP layer), a lower insulation layer (PP layer), an upper shielding layer (aluminum foil layer or copper foil layer) and a lower shielding layer (aluminum foil layer or copper foil layer). As aforementioned, no secondary processing adhesives are essential and required for preparation of the flexible flat cable (FFC) according to the present application. The both surfaces (inner surface and the outer surface; the inner surface is defined as a surface facing the parallel arranged conductors and the outer surface is defined as a surface facing the shielding layer) of the polypropylene (PP) layer have been modified to be more adhesible. First, the polypropylene (PP) layer can be adhered with the shielding layer (aluminum foil layer or copper foil layer). In one embodiment, the polypropylene (PP) layer and the shielding layer are aligned to be in contact with each other in their respective surfaces before moving toward a heating roller. Then, this step of adhering the shielding layer with the polypropylene (PP) layer can be implemented by thermal pressing to the side of the shielding layer with the heating roller.

After the polypropylene (PP) layers adhered with the shielding layers are prepared, two polypropylene (PP) layers sandwiching the parallel arranged conductors inbetween (the shielding layers are at the outer sides facing the heating rollers) are rolled into a slit between two heating rollers, again. The two heating rollers are employed to thermally press the two polypropylene (PP) layers to be firmly adhered with each other, so as to firmly sandwich the parallel arranged conductors between the two polypropylene (PP) layers as shown in FIG. 13.

Particularly, a certain thickness of the modified surface layer of the polypropylene (PP) layer exists (as the surface of the PP layer is modified, the certain thickness with adhesibility is provided to the PP layer). Moreover, as considering the properties of the polypropylene (PP) layer, for having providing a better bendability and a fine shape maintainability (under the premise of maintaining good electrical properties), a thickness of the polypropylene (PP) layer is preferably in a range of 0.03 mm to 0.3 mm. Significantly, the certain thickness of the modified surface layer of the PP layer is preferably at least equal to or larger than a half of the thickness of the parallel arranged conductors (as the conductors are round, the thickness is defined as the diameter of the conductors). Thus, the surfaces of the parallel arranged conductors can be completely covered by the modified surfaces of the two polypropylene (PP) layers when the two polypropylene (PP) layers are thermally pressed by the two heating rollers. Alternatively, one surface-modified polypropylene (PP) layer is provided to be adhered with the other polypropylene (PP) layer, which the surface is not modified. In such scenario, the thickness of the modified surface of the PP layer is preferably equal to or larger than the thickness of the parallel arranged conductors.

Significantly, through experiments and verifications, the electrical characteristics of the flexible flat cable (FFC) of the present application are much better than the electrical characteristics of the flexible flat cable (FFC) made of expensive insulation layers (such as the insulation layers made of ultra-high molecular weight polyethylene (UHMW-PE)) or the polytetrafluoroethylene (PTFE). Under the conditions of relatively more simple process and relatively lower manufacturing cost, the present invention still exhibits more excellent electrical characteristics of the flexible flat cable (FFC).

The present disclosure has been described with a preferred embodiment thereof. The preferred embodiment is not intended to limit the present disclosure, and it is understood that many changes and modifications to the described embodiment can be carried out without departing from the scope and the spirit of the disclosure that is intended to be limited only by the appended claims.

What is claimed is:

1. A flexible flat cable with no secondary processing adhesives, comprising:
a plurality of parallel arranged conductors;
two insulation layers, having respective inner surfaces oppositely positioned to be adhered to sandwich the plurality of parallel arranged conductors;
two shielding layers, respectively adhered on respective outer surfaces of the two insulation layers, wherein at least one of the inner surfaces of the two insulation layers is modified to comprise a modified surface layer possessing adhesibility.

2. The flexible flat cable with no secondary processing adhesives according to claim 1, wherein the parallel arranged conductors are flat conductors.

3. The flexible flat cable with no secondary processing adhesives according to claim 1, wherein the parallel arranged conductors are round conductors.

4. The flexible flat cable with no secondary processing adhesives according to claim 1, wherein the two insulation layers are polypropylene (PP) layers.

5. The flexible flat cable with no secondary processing adhesives according to claim 4, wherein a thickness of the modified surface layer is equal to or larger than a thickness of the parallel arranged conductors.

6. The flexible flat cable with no secondary processing adhesives according to claim 4, wherein both the inner surfaces of the two insulation layers are modified to be the modified surface layers to possess adhesibility.

7. The flexible flat cable with no secondary processing adhesives according to claim 6, wherein a thickness of the modified surface layers is equal to or larger than a half of a thickness of the parallel arranged conductors.

8. The flexible flat cable with no secondary processing adhesives according to claim 1, wherein the shielding layers are aluminum foil layers or copper foils.

9. The flexible flat cable with no secondary processing adhesives according to claim 1, wherein an insertion loss of the flexible flat cable with no secondary processing adhesives is smaller than −15 dB as a tested frequency of the flexible flat cable with no secondary processing adhesives is lower than 35 GHz.

10. The flexible flat cable with no secondary processing adhesives according to claim 1, wherein an insertion loss of the flexible flat cable with no secondary processing adhesives is smaller than −10 dB as a tested frequency of the flexible flat cable with no secondary processing adhesives is lower than 35 GHz.

11. The flexible flat cable with no secondary processing adhesives according to claim 1, wherein an insertion loss of the flexible flat cable with no secondary processing adhesives is smaller than −25 dB as a tested frequency of the flexible flat cable with no secondary processing adhesives is lower than 40 GHz.

12. The flexible flat cable with no secondary processing adhesives according to claim 1, wherein an insertion loss of the flexible flat cable with no secondary processing adhesives is smaller than −10 dB as a tested frequency of the flexible flat cable with no secondary processing adhesives is lower than 40 GHz.

13. The flexible flat cable with no secondary processing adhesives according to claim 1, wherein surfaces of the parallel arranged conductors are formed with tin before the parallel arranged conductors are sandwiched by the two insulation layers.

14. The flexible flat cable with no secondary processing adhesives according to claim 1, wherein surfaces of the parallel arranged conductors are formed with silver before the parallel arranged conductors are sandwiched by the two insulation layers.

15. The flexible flat cable with no secondary processing adhesives according to claim 1, wherein a melting point of the modified surface layer is lower than a melting point of the two insulation layers.

16. The flexible flat cable with no secondary processing adhesives according to claim 1, wherein a thickness of the insulation layers is in a range of 0.03 mm to 0.3 mm.

17. The flexible flat cable with no secondary processing adhesives according to claim 1, wherein the two insulation layers are polyolefin layers.

18. A flexible flat cable with no secondary processing adhesives, comprising:
a plurality of parallel arranged conductors;
two insulation layers, having respective inner surfaces oppositely positioned to be adhered to sandwich the plurality of parallel arranged conductors;
two shielding layers, respectively adhered on respective outer surfaces of the two insulation layers, wherein at least one of the outer surfaces of the two insulation layers is modified to comprise a modified surface layer possessing adhesibility.

19. The flexible flat cable with no secondary processing adhesives according to claim 18, wherein the two insulation layers are polypropylene (PP) layers.

20. The flexible flat cable with no secondary processing adhesives according to claim 19, wherein both the outer surfaces of the two insulation layers are modified to be the modified surface layers to possess adhesibility.

21. The flexible flat cable with no secondary processing adhesives according to claim 18, wherein the shielding layers are aluminum foil layers or copper foils.

22. The flexible flat cable with no secondary processing adhesives according to claim 18, wherein a melting point of the modified surface layer is lower than a melting point of the two insulation layers.

23. The flexible flat cable with no secondary processing adhesives according to claim 18, wherein a thickness of the insulation layers is in a range of 0.03 mm to 0.3 mm.

24. The flexible flat cable with no secondary processing adhesives according to claim 18, wherein an insertion loss of the flexible flat cable with no secondary processing adhesives is smaller than −15 dB as a tested frequency of the flexible flat cable with no secondary processing adhesives is lower than 35 GHz.

25. The flexible flat cable with no secondary processing adhesives according to claim 18, wherein an insertion loss of the flexible flat cable with no secondary processing adhesives is smaller than −10 dB as a tested frequency of the flexible flat cable with no secondary processing adhesives is lower than 35 GHz.

26. The flexible flat cable with no secondary processing adhesives according to claim 18, wherein an insertion loss of the flexible flat cable with no secondary processing adhesives is smaller than −25 dB as a tested frequency of the flexible flat cable with no secondary processing adhesives is lower than 40 GHz.

27. The flexible flat cable with no secondary processing adhesives according to claim 18, wherein an insertion loss of the flexible flat cable with no secondary processing adhesives is smaller than −10 dB as a tested frequency of the flexible flat cable with no secondary processing adhesives is lower than 40 GHz.

28. The flexible flat cable with no secondary processing adhesives according to claim 18, wherein the two insulation layers are polyolefin layers.

29. The flexible flat cable with no secondary processing adhesives according to claim 18, wherein surfaces of the parallel arranged conductors are formed with tin before the parallel arranged conductors are sandwiched by the two insulation layers.

30. The flexible flat cable with no secondary processing adhesives according to claim 18, wherein surfaces of the parallel arranged conductors are formed with silver before the parallel arranged conductors are sandwiched by the two insulation layers.
